(19) United States
(12) Patent Application Publication
(10) Pub. No.: US 2008/0162010 A1
(43) Pub. Date: Jul. 3, 2008

(54) Driver Assistance System with Travel Route Envelope Prediction

(76) Inventors: Albrecht Klotz, Aichtal (DE); Volker Brichzin, Ludwigsburg (DE)

Correspondence Address: KENYON & KENYON LLP, ONE BROADWAY, NEW YORK, NY, 10004, US

(21) Appl. No.: 11/794,014

(22) PCT Filed: Jan. 9, 2006
(86) PCT No.: PCT/EP06/50091

§ 371 Date: Dec. 21, 2007

(30) Foreign Application Priority Data
Jan. 19, 2005 (DE) 102005002504.8

(51) Int. Cl. B60W 30/14; G08G 1/00

(52) U.S. Cl. 701/93; 701/117

(57) ABSTRACT

A driver assistance system for motor vehicles, having a sensor system (16, 18) for acquiring the surrounding traffic environment, a prediction device (12) for predicting a travel route envelope (42, 46) that the vehicle (36) is expected to travel, and an assistance function (10a, 10b, 10c) that makes use of the predicted travel route envelope,

wherein the prediction device (12) is fashioned so as to simultaneously pursue a plurality of travel route envelope hypotheses (32, 34) and to make them available to the assistance function (10a, 10b, 10c).

### BACKGROUND OF THE INVENTION

1. Field of the Invention

The present invention relates to a driver assistance system for motor vehicles, having a sensor mechanism for acquiring the surrounding traffic environment, a prediction device for predicting a travel route envelope that the vehicle is expected to follow, and an assistance function that makes use of the predicted travel route envelope.

2. Description of Related Art

In driver assistance systems that support the driver in the driving of the vehicle, warn the driver of acute danger situations, introduce automatic measures for avoiding a threatened collision, or activate safety systems in preparation for a collision, it is often necessary to predict the course that the home vehicle is expected to follow. A typical example of such a driver assistance system is a dynamic speed regulator, or ACC (adaptive cruise control) system, which regulates the speed of the home vehicle automatically to the speed of a vehicle traveling in front of the home vehicle that has been located using a radar or lidar sensor system. The travel route envelope prediction is then used primarily in order to decide whether an acquired object is to be selected as target object for the distance regulation, or whether this object is an irrelevant object, e.g., a vehicle in an adjacent lane. The travel route envelope is represented for example by a geometrical object defined by a center line, corresponding to the trajectory of the vehicle, and a particular travel route envelope width. The selection of a target object then takes place under the premise that only vehicles within the travel route envelope are relevant for the distance or speed regulation.

Such ACC systems are already in use, but their area of application has up to now been limited mainly to driving on highways or on well-constructed rural roads. In these situations, the analysis of the traffic environment can be limited to moving objects, for example vehicles traveling in front of the home vehicle, while stationary objects, for example objects at the edge of the roadway, can be ignored. In order to predict the travel route envelope, in such systems first of all the current speed of the home vehicle and the yaw rate of the home vehicle are taken into account. On the basis of these data, a travel route envelope hypothesis is produced by mathematically describing the center line of the travel route envelope as a parabola whose curvature is given by the ratio of the yaw rate and the vehicle speed.

Efforts are being made to expand the area of application of ACC systems to other traffic situations, e.g., stop-and-go situations on highways (traffic jam assistants), travel on rural roads, and also travel in city traffic. In these situations, in which in general stationary objects must also be taken into account, making the selection of valid target objects and the recognition of obstacles significantly more complex, higher demands are also made on the precision of the travel route envelope prediction.

For travel route envelope prediction, it has already been proposed to additionally use data from other information sources, e.g., the collective movements of other vehicles, which can be acquired using the radar system, data from a navigation system, location data of stationary objects at the edge of the roadway, or information supplied by a mono or stereo video system, permitting a determination of the available driving space.

In addition, the results of the travel route envelope prediction are capable of being used not only in conventional ACC systems and advanced ACC systems having expanded functionality, but also in other assistance systems, for example warning and/or safety systems, in which an impending collision of the home vehicle with an obstacle must be recognized.

### BRIEF SUMMARY OF THE INVENTION

The present invention offers the advantage that different demands, possibly changing in accordance with the particular situation, on the travel route envelope prediction can be taken into account better and more quickly.

This is achieved in that the projection device is fashioned so as to follow a plurality of travel route envelope hypotheses simultaneously and to make them available to the assistance function.

From the plurality of travel route envelope hypotheses, the subsequently connected assistance function can then select as the predicted travel route envelope the one that best corresponds to the indicated functional purpose and/or the given situation. This not only facilitates control over ambiguous situations, e.g., at intersections or forks in the road, but above all also makes it possible to adapt the various travel route envelope hypotheses more precisely to the respective functional purpose, or to various characteristic situations, e.g., by using, for each of the parallel travel route envelope hypotheses, different sources of information, different rules for interpreting the information, and/or different rules for constructing the travel route envelope. The subsequent assistance function then selects the best-suited travel route envelope hypothesis in accordance with the situation or functional purpose, and can quickly change over to a different hypothesis if the situation or the operating mode of the assistance function changes.

In addition, it is possible to accommodate a plurality of different assistance functions on a common sensor mechanism and a common information base, the prediction device making available to each assistance function one or more travel route envelope hypotheses that are determined specifically for this function.

In an example embodiment, the various travel route envelope hypotheses are each constructed so as to correspond to the different conceivable behaviors of the driver, and the selection of the predicted travel route envelope then takes place on the basis of a recognition and analysis of the driver's reactions that permit conclusions as to his intentions, e.g., driving actions, settings of the travel direction indicator, etc.

For example, in the context of an expanded ACC function that is also suitable for city driving, besides a standard operating mode, a special operating mode is also conceivable that is activated automatically or by driver command when obstacles that are blocking only a part of the home lane, e.g., bicyclists or stationary vehicles on the edge of the roadway, are to be overtaken or driven around. In this case, the travel route envelope is constructed in such a way that it takes into account the evasive maneuver to be expected on the part of the driver. This operating mode can therefore also be referred to as “ACC travel in the available driving space.” The travel route envelope hypothesis prepared by the prediction device for ACC travel in the available driving space can be also be used, in identical or similar form, for a traffic jam assistant implemented in the same assistance system. It is also conceivable that, parallel to the assistance function or to the traffic jam assistant, another warning or safety function is running; for example, this could be what is known as a pre-crash function, which also makes use of the travel route envelope hypothesis for ACC travel in the available driving space, or makes use of a slightly modified travel route envelope hypothesis.

According to the present invention, not only are parallel travel route envelope hypotheses prepared, but the further evaluation may also take place largely in parallel fashion. For example, in an ACC system the plausibilization of the objects, the allocation of the objects to the travel route envelope, and the selection of the target object, as well as, if warranted, the production of a corresponding rule proposal for the distance regulation according to travel route envelope hypotheses, can be carried out separately and in parallel, so that the decision in favor of one hypothesis or another is not made until the rule proposal has been implemented. This has the advantage that the rule system is, as it were, always prepared for all eventualities.

The parallel prosecution of a plurality of travel route envelope hypotheses is particularly useful in cases in which the production of these hypotheses is based on information relating to past procedures. Thus, for example in the context of an ACC function, the trajectories of the located objects are followed over a longer period of time. Under the assumption that in an area where another vehicle has moved there must also exist a possible travel route envelope for the home vehicle, the trajectories followed in this way can be used in order to create travel route envelope hypotheses. However, this presupposes that the trajectory has already been followed for a certain period of time. If a plurality of travel route envelope hypotheses are maintained in parallel, the advantage thus results that the required information is immediately available when needed. This holds not only for the prosecution of trajectories, but also for example for the interpretation of other infrastructure data, e.g., roadway markings located using a video system and the like. In the interpretation and plausibilization of such objects as well, recourse is often had to the history, e.g., in order to enable the stability of the object location to be evaluated.

### BRIEF DESCRIPTION OF THE SEVERAL VIEWS OF THE DRAWINGS

FIG. 1 shows a block diagram of a driver assistance system.

FIGS. 2 and 3 show diagrams illustrating two different travel route envelope hypotheses applied by the present system.

FIG. 4 shows a flow-chart illustrating exemplary method steps of the application of the present invention.

### DETAILED DESCRIPTION OF THE INVENTION

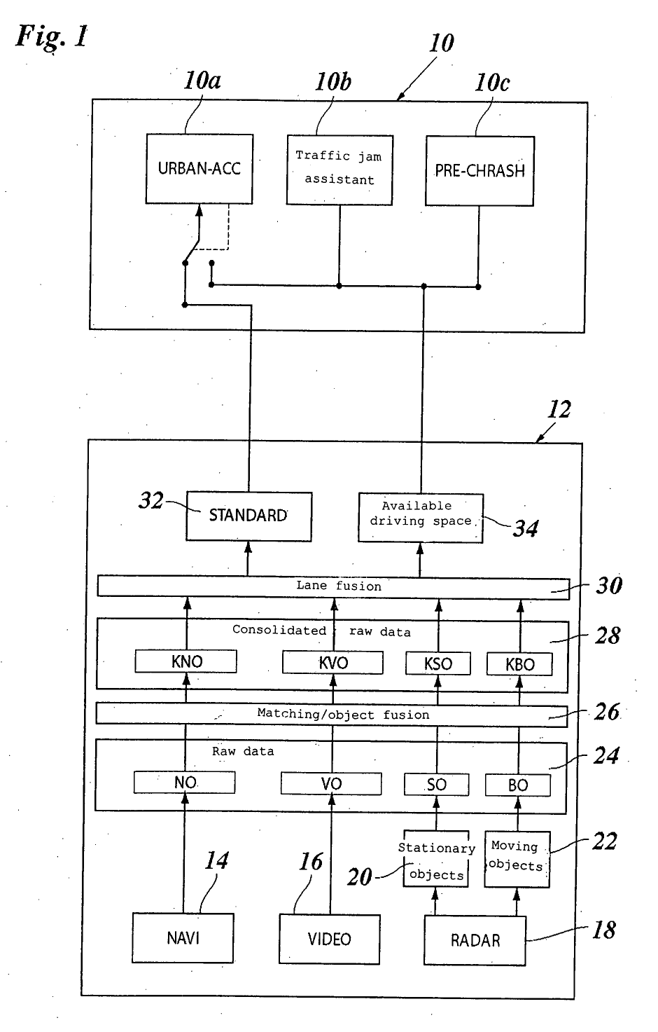

FIG. 1 shows a driver assistance system in which different assistance functions 10a, 10b, and 10c are implemented, e.g., an URBAN-ACC function, a traffic jam assistant, and a warning and safety system. The expression “URBAN ACC” indicates that the system is intended also to be suitable for city driving. Driver assistance system 10 is formed by one or more microcomputers and associated software, and is therefore represented only schematically as a block. The associated sensor system is also not shown in more detail in FIG. 1. Only the functions of the system that relate to travel route envelope prediction are indicated as a separate block 12.

For travel route envelope prediction, in the depicted example the following information sources are available: a navigation system 14, which supplies for example information concerning roadway curves, intersections, and the like, a video system 16, and a radar system 18, which also provides the data for the distance regulation in the context of the ACC function. Radar system 18 locates both stationary objects 20 and also moving objects 22. The corresponding location data are evaluated in different ways, so that the stationary objects and the moving objects are here treated as different information sources.

From the four sources of information, raw data 24 are extracted. These raw data 24 are represented mathematically as geometrical objects in a unified two-dimensional coordinate system. These objects are designated NO, VO, SO, BO, in accordance with the information source. In a method stage 26, designated “matching/object fusion,” the raw data are interpreted and adapted to one another in order to determine possible contradictions and remove them to the greatest possible extent, and to correct imprecisions resulting from the nature of the respective information source. Here, for example individual objects recognized by the video system can also be identified with corresponding radar targets (object fusion). In addition, there takes place here a plausibilization of the recognized objects, generally making use of the history, i.e., earlier data allocated to the same object. In this way, consolidated raw data 28 are obtained, designated KNO, KVO, KSO, and KBO. Typically, these data represent line objects, such as for example the course of center stripes and edge marking lines on the roadway (KVO, derived from the video data), roadway edges derived from series of stationary objects (KSO, obtained through the fusion of radar and video data), and vehicle trajectories (KBO, derived from radar and possibly video data).

In a step 30, “lane fusion,” the raw data for mutually corresponding line objects are combined by generating new synthetic line objects from the parameters and coefficients that describe the individual line objects; each of these new line objects corresponds to a travel route envelope hypothesis 32, 34. In the depicted example, for the sake of simplicity only two travel route envelope hypotheses are shown, but their number can also be greater than two.

During the matching and in the interpretation of the raw data, and in the fusion of these data, different criteria and rules are used for each of the two travel route envelope hypotheses 32 and 34, adapted specifically to their respective functional purpose.

The rules for travel route envelope hypothesis 32 correspond to a standard ACC function (assistance function 10a), and are based on the assumption that the travel route envelope corresponds approximately to the overall width of the roadway lane in which the home vehicle is currently traveling or is expected to travel.

The rules for travel route envelope hypothesis 34 are adapted to ACC travel in the available driving space, and are accordingly based on the assumption that in the case of obstacles that do not completely block the current or expected lane, but rather merely narrow it somewhat, the travel route envelope will be displaced and possibly narrowed so as to correspond to a circumvention of the obstacle within the home lane. This travel route envelope hypothesis 34 is made available to all three assistance functions 10a, 10b, and 10c. Assistance function 10a, “Urban ACC,” is thus provided with two travel route envelope hypotheses 32 and 34 for selection. For standard ACC travel, the assumption is made that the driver wishes to be supported during forward driving of the vehicle, i.e. during acceleration and/or braking, and that accordingly the home vehicle must be comfortably regulated in the forward direction. The driver will engage in transverse driving of the vehicle only in order to maintain the lane and for lane change maneuvers.

In contrast, for traffic jam assistant 10b, which is activated automatically or by the driver when there is a traffic jam on a highway, the assumption is made that the driver would like to be guided rapidly and comfortably through the traffic jam, so that the driver is also prepared to execute passing maneuvers within the home lane given vehicles traveling in a staggered pattern. The same also holds in specific situations for the urban ACC function, for example given vehicles traveling in a staggered pattern on the right edge of the roadway (e.g. bicyclists), which are preferably to be overtaken within the city. In such cases, the driver expects that the urban ACC system, or the traffic jam assistant, will not react to the staggered vehicles, as long as sufficient driving space is available for comfortable passing or circumvention.

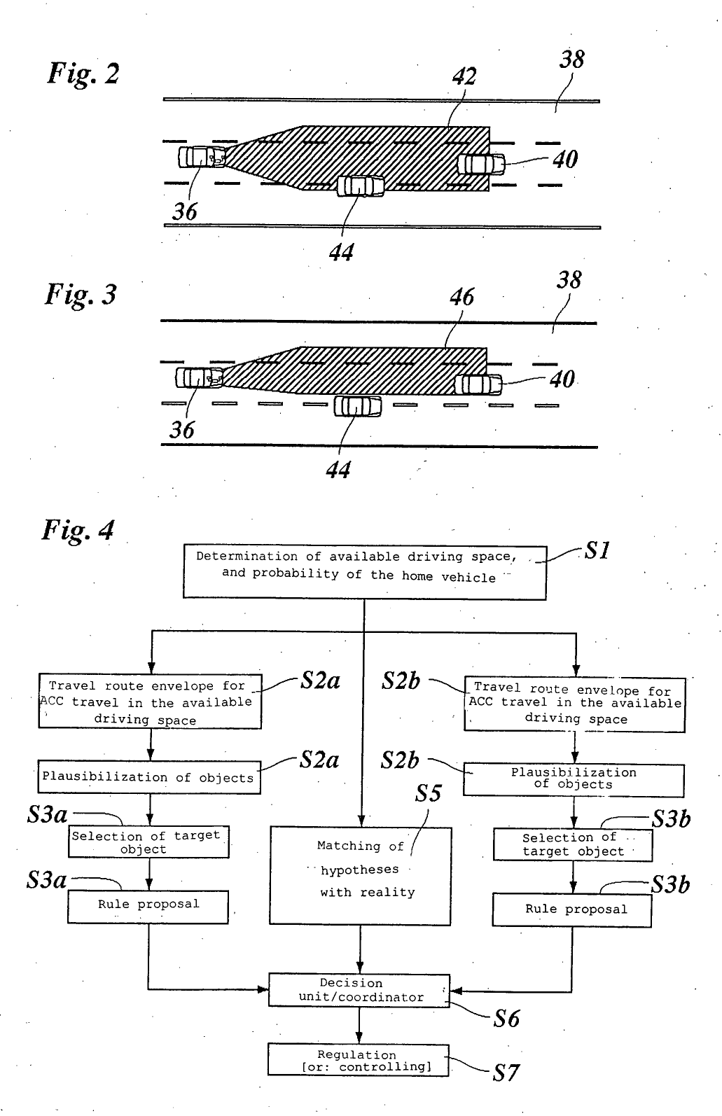

The various driver expectations and travel route envelope constructions are illustrated in FIGS. 2 and 3.

FIG. 2 shows the home (i.e., controlled) vehicle 36, equipped with driver assistance system 10 and with an associated sensor mechanism in the form of a video camera and a radar sensor, situated on the center lane of a three-lane roadway 38. In the context of the standard ACC function, a vehicle 40 driving in front of the home vehicle is being followed. Consequently, the prediction of a travel route envelope 42 takes place on the basis of travel route envelope hypothesis 32. Travel route envelope 32 extends at least over the entire width of the lane in which home vehicle 36 is situated, and therefore also includes a vehicle 44 situated at the right edge of the roadway and extending partially into the center lane. The ACC function will therefore locate vehicle 44 as a relevant object, and will initiate a corresponding delay, and, if necessary, a stopping, of home vehicle 36.

For comparison, FIG. 3 illustrates the construction of a travel route envelope 46 that is based on travel route envelope hypothesis 34 and is provided for ACC travel in the available traffic space. Travel route envelope 46 is limited in such a way that vehicle 44 is now situated completely outside this travel route envelope, and is no longer treated as a relevant object. This corresponds to the expectation that the driver intends to drive around vehicle 44 without significantly departing from the home lane. In a traffic jam situation, this would be an appropriate reaction.

In city traffic, i.e., given an active urban ACC, the circumvention of obstacles within the home lane can sometimes be an appropriate reaction, e.g., when overtaking a bicyclist, but in other situations may not be appropriate, for example when approaching a motorcyclist at the end of a line at a traffic light. In the context of assistance function 10a, it must therefore be decided at an appropriate point in time which of the two travel route envelope hypotheses 32, 34 will be used as the basis of the regulation. A flow diagram for this is shown in FIG. 4.

In step S1, the available driving space is determined on the basis of the data from navigation system 14, video system 16, and radar system 18, and the probability is determined that the home vehicle will follow one or another of the available routes. In steps S2a and S2b, the two travel route envelope hypotheses 32 and 34 are then calculated and pursued in parallel. In steps S3a and S3b, for each travel route envelope hypothesis the located objects are tested for plausibility, i.e., in each case it is decided which objects are situated within the travel route envelope. In steps S3a and S3b, a target object is then selected in each case from the located objects, and, dependent on the location data of this target object, in steps S4a and S4b two alternative rule proposals are calculated. In the meantime, in step S5 the hypotheses concerning the expected behavior of the driver are compared with reality. For example, for this purpose on the basis of the yaw rate of the home vehicle it is determined whether or not the driver is initiating a driving maneuver in order to drive around the object. If necessary, other criteria can also be taken into account, such as the presence and/or trajectories of other objects, e.g., a passenger vehicle situated in front of the motorcyclist stopped at the end of the line at the traffic light. On this basis, in step S6 a decision is then made in favor of one rule proposal or the other, and in step S7 the corresponding control process is introduced. Step S6 here operates with a certain degree of hysteresis, so that in case of doubt a rapid change between opposed decisions is avoided.

1-9. (canceled)

10. A driver assistance system for a controlled motor vehicle, comprising:
a sensor system configured to acquire data regarding surrounding traffic environment;
a prediction device configured to predict a travel route envelope that the controlled motor vehicle is expected to travel; and
an assistance function unit that makes use of the predicted travel route envelope;
wherein the prediction device is configured to simultaneously analyze a plurality of travel route envelope hypotheses and provide the plurality of travel route envelope hypotheses to the assistance function unit.

11. The driver assistance system as recited in claim 10, wherein the prediction device is configured to generate the plurality of travel route envelope hypotheses on the basis of criteria and rules that differ for each travel route envelope hypothesis.

12. The driver assistance system as recited in claim 11, wherein the criteria and rules are each defined with regard to one of a traffic situation and an operating mode of the assistance function unit.

13. The driver assistance system as recited in claim 12, wherein the assistance function unit implements an adaptive cruise control function, and wherein the criteria and rules for a first travel route envelope hypothesis are based on an assumption that a driver of the controlled motor vehicle wishes to evaluate every object situated in a target lane being traveled by the controlled motor vehicle as an obstacle, and wherein the criteria and rules for a second travel route envelope hypothesis are based on an assumption that the driver of the controlled motor vehicle intends to drive around an object situated in the target lane, if driving around the object is possible.

14. The driver assistance system as recited in claim 12, wherein at least one assistance function implemented by the assistance function unit is a traffic jam assistance function, and wherein the criteria and rules for generating a travel route envelope hypothesis for the traffic jam assistance function are based on an assumption that a driver of the controlled motor vehicle intends to drive around an object situated in a target lane being traveled by the controlled motor vehicle, by using an available driving space within the target lane.

15. The driver assistance system as recited in claim 12, wherein the prediction device generates a plurality of travel route envelope hypotheses for each one of a plurality of assistance functions implemented.

16. The driver assistance system as recited in claim 12, wherein the assistance function unit is configured to initially process the plurality of travel route envelope hypotheses in parallel, and wherein the assistance function unit adopts in a subsequent processing stage a processing result that is based on one of the plurality of travel route envelope hypotheses.

17. The driver assistance system as recited in claim 16, wherein the assistance function unit implements a driving speed regulation.

18. The driver assistance system as recited in claim 12, wherein the prediction device is configured to process data that are supplied by the sensor system, and wherein the prediction device makes use of the history of the data that are supplied by the sensor system in generating the plurality of travel route envelope hypotheses.
